(19) United States
(12) Patent Application Publication
(10) Pub. No.: US 2013/0056448 A1
(43) Pub. Date: Mar. 7, 2013

(54) WIRE BONDING SYSTEM FOR SEMICONDUCTOR PACKAGE

(71) Applicants: Doo-jin Kim, Cheonan-si (KR); Sung-bok Hong, Cheonan-si (KR); Hyung-jin Lee, Cheonan-si (KR); Young-sik Kim, Cheonan-si (KR)

(72) Inventors: Doo-jin Kim, Cheonan-si (KR); Sung-bok Hong, Cheonan-si (KR); Hyung-jin Lee, Cheonan-si (KR); Young-sik Kim, Cheonan-si (KR)

(73) Assignee: Samsung Electronics Co., Ltd., Suwon-si (KR)

(21) Appl. No.: 13/535,873

(22) Filed: Jun. 28, 2012

(30) Foreign Application Priority Data
Sep. 6, 2011 (KR) 10-2011-0090203

(51) Int. Cl. B23K 26/00

(52) U.S. Cl. 219/121.63

(57) ABSTRACT

A wire bonding system of a semiconductor package comprising a wire feeding device for positioning a wire at a ball formation position, a laser beam generation unit for generating a carbon dioxide laser beam, and a laser beam guiding unit for directing the laser beam at the ball formation position to form a ball at the wire. Accordingly, moldability and producibility of the ball formed on the wire may be improved. Also, electrical properties at a section of the wire are modified so as to minimize a loop height of the wire.

### CROSS-REFERENCE TO RELATED APPLICATIONS

This application claims the benefit of Korean Patent Application No. 10-2011-0090203, filed on Sep. 6, 2011, in the Korean Intellectual Property Office, the disclosure of which is incorporated herein in its entirety by reference.

### BACKGROUND

1. Field

The inventive concepts relate to a wire bonding system for a semiconductor package, and more particularly, to a wire bonding system for a semiconductor package that forms a ball at a front end of a wire.

2. Description of Related Art

In general, a semiconductor package is formed by die-bonding at least one semiconductor chip on a surface of an element such as a lead frame or a printed circuit board, and wire bonding or soldering is performed to electrically connect leads of the lead frame or terminals of the printed circuit board to the semiconductor chip. The semiconductor chip is encapsulated by covering the semiconductor chip with an insulating encapsulation material. When performing a wire bonding operation, in order to obtain electrical bonding properties, an electrical discharge is generated using a torch tip at a front end of a conductive wire to form spherical balls, which may be bonded at a bonding pad of a semiconductor chip.

### SUMMARY

Embodiments of the inventive concepts include a wire bonding system for a semiconductor package, in which a ball having a small size and a precise and uniform shape may be quickly formed, wherein a loop height of wires may be minimized, and costs and time for exchanging various consumed components may be reduced.

According to an aspect of the inventive concepts, there is provided a wire bonding system for a semiconductor package, comprising: a wire feeding device for positioning a wire at a ball formation position; a laser beam generation unit for generating at least one laser beam; and a laser beam guiding unit for directing the at least one laser beam at the ball formation position to form a ball at the wire.

In an embodiment, the laser beam generation unit includes a high power laser beam output unit.

In an embodiment, the laser beam generation unit comprises a first carbon dioxide laser resonator, the first carbon dioxide laser resonator comprising: a sealed resonance tube; a resonance gas that is injected into the sealed resonance tube, the resonance gas including at least a carbon dioxide component; a total reflector constructed and arranged at a first side in the sealed resonance tube; a partial reflector constructed and arranged at a second side in the sealed resonance tube; a pair of electrodes for applying flash light energy into the sealed resonance tube; and a power unit for supplying power to the pair of electrodes.

In an embodiment, the laser beam generation unit comprises a second carbon dioxide laser resonator, the second carbon dioxide laser resonator comprising: a sealed resonance tube; a resonance gas that is injected into the sealed resonance tube, the resonance gas including at least a carbon dioxide component; a total reflector mirror constructed and arranged at a first side in the sealed resonance tube; a partial reflector mirror constructed and arranged at a second side in the sealed resonance tube; a pair of electrodes for applying flash light energy into the sealed resonance tube; and a power unit for supplying power to the pairs of electrodes.

In an embodiment, the wire bonding system further comprises at least one high output unit that combines a first laser beam emitted from the first carbon dioxide laser resonator and a second laser beam emitted from the second carbon dioxide laser resonator.

In an embodiment, the high output unit comprises an inclined total reflector and an inclined partial reflector.

In an embodiment, the wire bonding system further comprises an angle adjusting unit that is installed on the laser beam guiding unit and adjusts an irradiation angle of a laser beam emitted from the laser beam guiding unit to the ball formation position.

In an embodiment, the wire bonding system further comprises the angle adjusting unit comprises a joint unit having a hinge axis.

In an embodiment, the wire bonding system the irradiation angle is about 40 to 50 degrees with respect to an axis direction of a wire.

In an embodiment the laser beam guiding unit comprises: an optical fiber line that is extended from the laser beam generation unit; a laser beam emitting unit that is installed at a tip of the optical fiber line and comprises an optical fiber, a lens, or a combination thereof; a vertical position adjusting unit that is installed on the optical fiber line and adjusts a vertical position of the laser beam emitting unit; and a horizontal position adjusting unit that is installed on the optical fiber line and adjusts a horizontal position of the laser beam emitting unit.

In an embodiment, the laser beam emitting unit comprises a first laser beam emitting unit disposed at an irradiation angle of about 40 to 50 degrees with respect to an axis direction of the wire.

In an embodiment, the laser beam emitting unit comprises a second laser beam emitting unit disposed at an irradiation angle of about 40 to 50 degrees with respect to an axis direction of the wire on a side opposite the first laser beam emitting unit.

In an embodiment, the laser beam emitting unit comprises a third laser beam emitting unit disposed at an irradiation angle of about 85 to 95 degrees with respect to the axis direction of the wire.

In an embodiment, the wire feeding device comprises: a spool on which the wire is wound; a wire tensioning device for maintaining the wire unwound from the spool, in a vertical state; a wire clamp for selectively clamping the wire in the vertical state; a transducer for applying a minute vibration to the wire; and a capillary for fixing a front end position of the wire to perform wire bonding.

In an embodiment, the laser beam output unit outputs at least one carbon dioxide laser beam.

According to another aspect of the inventive concepts, there is provided a wire bonding system for a semiconductor package, comprising: a wire feeding device for positioning a wire at a ball formation position; a laser beam generation unit for generating at least one laser beam; and a laser beam guiding unit for directing the at least one laser beam generated from the laser beam generation unit at the ball formation position at an angle of about 40 to 50 degrees with respect to a direction of extension of the wire.

According to another aspect of the inventive concepts, there is provided a system for forming a ball on a wire at a semiconductor package, comprising: a laser beam generation unit for generating at least one laser beam; and a laser beam guiding unit for directing the at least one laser beam at a region of the wire.

In an embodiment, the system further comprising a wire feeding device for positioning the wire at a direction of extension, a region of the wire including a ball formation position, the laser beam guiding unit directing the at least one laser beam at the ball formation position to form the ball.

In an embodiment, the laser beam generation unit comprises a laser shutter for determining a size of the ball formed on the wire.

In an embodiment, the laser beam guiding unit includes a laser beam emitting unit that directs the at least one laser beam at the region of the wire at an irradiation angle with respect to the direction of extension of the wire.

### BRIEF DESCRIPTION OF THE DRAWINGS

Exemplary embodiments of the inventive concepts will be more clearly understood from the following detailed description taken in conjunction with the accompanying drawings in which:

FIG. 1 is a schematic view illustrating a wire bonding system for a semiconductor package according to an embodiment of the inventive concepts;

FIG. 2 is an expanded view of a laser beam emitting unit illustrated in FIG. 1, according to an embodiment of the inventive concepts;

FIG. 3 is an expanded view of a laser beam emitting unit illustrated in FIG. 1, according to another embodiment of the inventive concepts;

FIG. 4 is an expanded view of a laser beam emitting unit illustrated in FIG. 1, according to another embodiment of the inventive concepts;

FIG. 5 is an expanded view of a laser beam emitting unit illustrated in FIG. 1, according to another embodiment of the inventive concepts;

FIG. 6 is an expanded view of a laser beam emitting unit illustrated in FIG. 1, according to another embodiment of the inventive concepts;

FIG. 7 is an expanded view of a laser beam guiding unit illustrated in FIG. 1, according to an embodiment of the inventive concepts;

FIG. 8 is a schematic view illustrating a laser beam generation unit illustrated in FIG. 1, according to an embodiment of the inventive concepts; and

FIG. 9 is a schematic view illustrating a laser beam generation unit according to another embodiment of the inventive concepts.

### DETAILED DESCRIPTION OF THE EMBODIMENTS

Expressions such as “at least one of”, when preceding a list of elements, modify the entire list of elements and do not modify the individual elements of the list.

The inventive concepts will now be described more fully with reference to the accompanying drawings, in which exemplary embodiments of the inventive concepts are shown. The inventive concepts may, however, be embodied in many different forms and should not be construed as being limited to the embodiments set forth herein; rather, these embodiments are provided so that this disclosure will be thorough and complete, and will fully convey the concepts of the inventive concepts to those skilled in the art. In the drawings, the thicknesses of layers and regions are exaggerated for clarity.

It will be understood that when a component such as a layer, a region, or a substrate is referred to as being “on”, “connected to”, or “coupled to” another component throughout the specification, it can be directly on, connected to, or coupled to the other component, or intervening layers may also be present. On the other hand, when a component is referred to as being “directly on”, “directly connected to”, or “directly coupled to” another component, it will be understood that no intervening layer is present. Like reference numerals denote like elements. As used in the present specification, the term “and/or” includes any and all combinations of one or more of the associated listed items.

In the present description, terms such as “first”, “second”, etc. are used to describe various members, components, regions, layers, and/or portions. However, it is obvious that the members, components, regions, layers, and/or portions should not be defined by these terms. The terms are used only for distinguishing one member, component, region, layer, or portion from another member, component, region, layer, or portion. Thus, a first member, component, region, layer, or portion that will be described may also refer to a second member, component, region, layer, or portion, without departing from the teaching of the inventive concepts.

Relative terms, such as “lower”, “bottom”, “upper”, or “top”, may be used herein to describe one element's relationship to another element as illustrated in the figures. It will be understood that the relative terms are intended to encompass different orientations of the device in addition to the orientation depicted in the figures. For example, if the device in the figures is turned over, elements described as being on the “upper” side of other elements would then be oriented on the “lower” side of the other elements. The example term “upper”, can therefore, encompass both an orientation of “lower” and “upper”, depending on the particular orientation of the figure. If the device is oriented in a direction different from the drawings, for example, rotated by 90° with respect to the direction, the description on the relative terms of the present specification can be understood accordingly.

The terminology used herein is for the purpose of describing particular embodiments only and is not intended to be limiting of example embodiments. As used herein, the singular forms “a,” “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Embodiments of the inventive concepts are described herein with reference to cross-section illustrations that are schematic illustrations of idealized embodiments (and intermediate structures) of the inventive concepts. As such, variations from the shapes of the illustrations as a result, for example, of manufacturing techniques and/or tolerances, are to be expected. Thus, embodiments of the inventive concepts should not be construed as limited to the particular shapes of regions illustrated herein but are to include deviations in shapes that result, for example, from manufacturing.

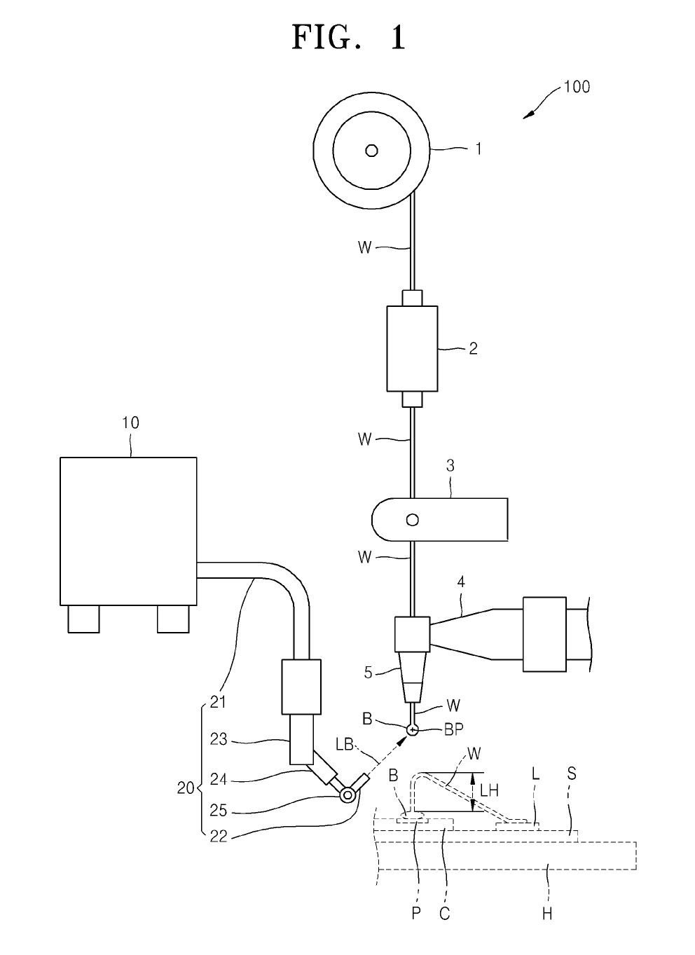

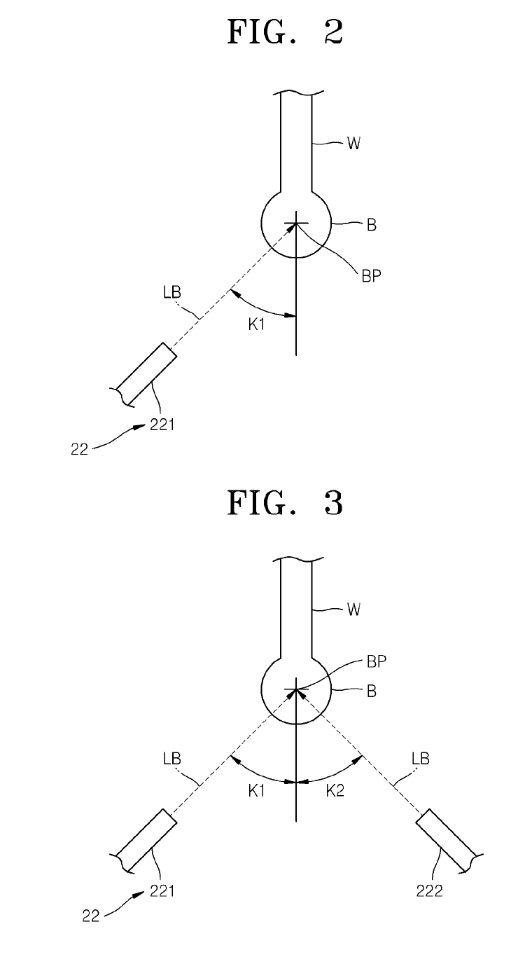

FIG. 1 is a schematic view illustrating a wire bonding system for a semiconductor package according to an embodiment of the inventive concepts. FIG. 2 is an expanded view of a laser beam emitting unit 22 illustrated in FIG. 1, according to an embodiment of the inventive concepts.

As illustrated in FIGS. 1 and 2, the wire bonding system of a semiconductor package according to an embodiment includes a wire feeding device 100, a laser beam generation unit 10, and a laser beam guiding unit 20.

In detail, as illustrated in FIG. 1, the wire feeding device 100 feeds a conductive wire W to a ball formation position BP. The wire feeding device 100 may include a spool 1, a wire tensioning unit 2, a wire clamp 3, a transducer 4, and a capillary 5.

The wire W is wound around the spool 1 for temporary storage. Although not shown in FIG. 1, as the spool 1 rotates, for example, via a motor, the wire W is unwound by an appropriate predetermined length so as to be fed to the ball formation position BP.

The wire tensioning unit 2 can apply tension to the wire W unwound from the spool 1 using an elastic device such as a spring or a weight or the like to maintain the wire W at a state, for example, a relatively vertical position.

The wire clamp 3 can repeat an opening operation and a closing operation to selectively clamp the wire W, for example, in a vertical state, so that the wire W is selectively fed to the ball formation position BP.

The transducer 4 may be connected between an ultrasonic oscillator and the like (not shown) and the wire feeding device 100, for example, the capillary 5, so as to apply a minute vibration energy such as an ultrasonic vibration to the wire W, thereby increasing wire bonding properties when performing wire bonding.

The capillary 5 includes a minute through hole formed therein. The through hole includes a feeding path for the wire W. A front end portion of the wire W is positioned such that the wire W can be withdrawn from an end of the through hole in order to align the wire W and a ball B before wire bonding or to cut the wire W after the bonding.

The ball B is formed at the front end of the wire W and is bonded to a bonding pad P of a semiconductor chip C. As illustrated in FIG. 1 by a dotted line, the bonding pad P of the semiconductor chip C and a lead L of a substrate S or a substrate pad may be electrically connected to each other by wire bonding. Also, during wire bonding, the ball B receives ultrasonic minute vibration energy from the transducer 4, which will be described later, and also receives, at the same time, thermal energy from the substrate S mounted on a heating block H, thereby facilitating bonding.

The wire W is a type of signal transmission medium that electrically connects the bonding pad P of the semiconductor chip C and the lead L of the substrate S or the substrate pad. The wire W may be formed of a conductive material such as, for example, gold (Au), silver (Ag), platinum (Pt), aluminum (Al), copper (Cu), palladium (Pd), nickel (Ni), cobalt (Co), chromium (Cr), or titanium (Ti), or a combination thereof. The wire W may be manufactured using a wire manufacturing apparatus known to those of ordinary skill in the art. The material of the wire W and the method of manufacturing the same are not limited thereto.

The semiconductor chip C may include one or more memory chips, control chips, driver chips, and microprocessor chips, or other chip. The chip C may be manufactured for a display device such as LCD devices, LED devices, etc. or according to any type of semiconductor process. The substrate S may be a memory board or a control substrate. The substrate S may be provided for any board applied to a memory device such as a memory stick card, a smart media (SM) card, a secure digital (SD) card, a mini SD card, and/or a multi media card (MMC). In accordance with wire bonding techniques described herein, an electronic system such as various types of controllers, input/output devices, memories, and interface devices may be manufactured. Examples of the electronic system may include but not limited to mobile devices such as personal digital assistants (PDAs), portable computers, web tablets, wireless phones, mobile phones, digital music players, and memory cards. The electronic system may also apply to but not limited to MP3 players, navigation devices, portable multimedia players (PMPs), solid state disks (SSDs), and household appliances.

Here, in the wire bonding system for a semiconductor package according to the current embodiment of the inventive concepts, the laser beam generation unit 10 and the laser beam guiding unit 20 may generate either no section or a minimum section, for example, a section of about 250 micrometers or less, in which an electrical property thereof is modified, to maintain ductility of wires in remaining sections, thereby minimizing the loop height LH of the wire W of FIG. 1. The laser beam generation unit 10 and the laser beam guiding unit 20 are described in detail below.

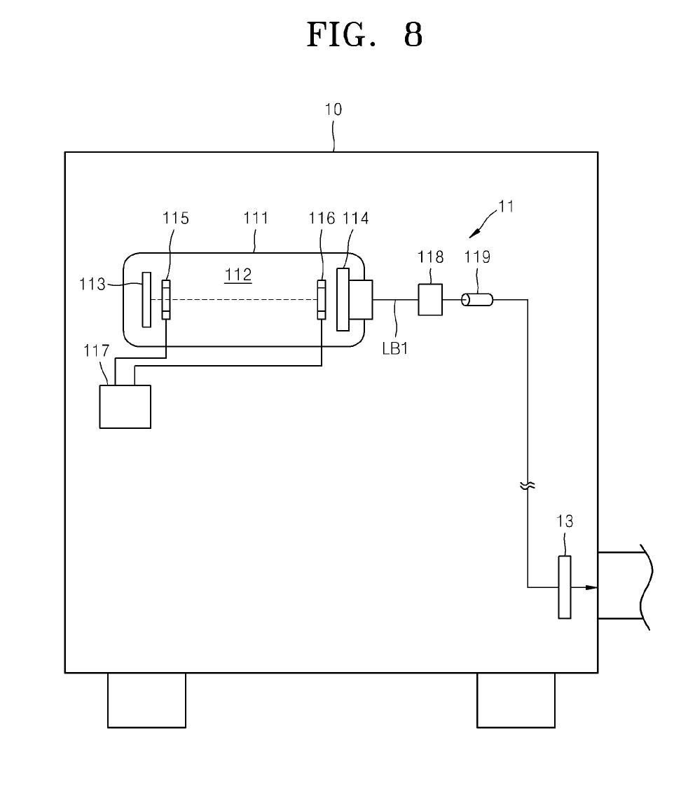

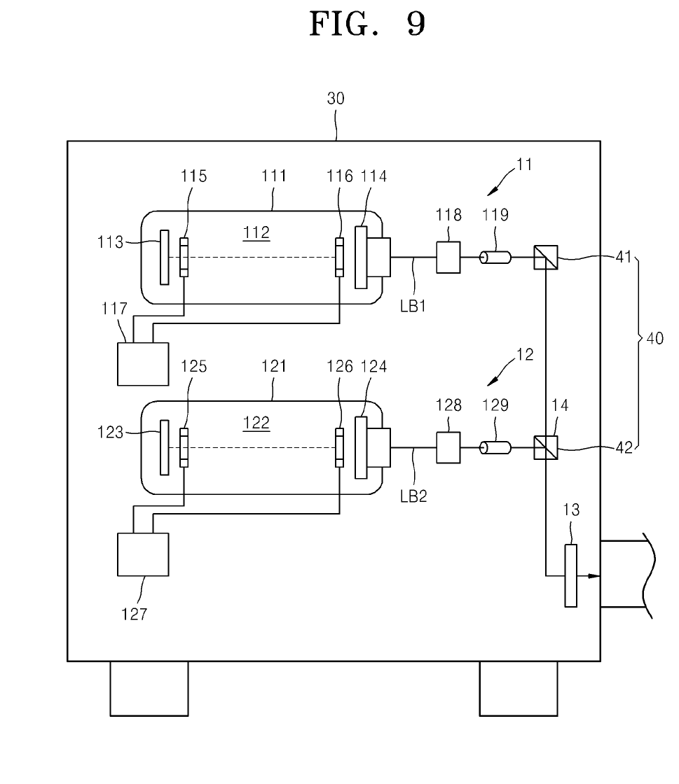

FIG. 8 is a schematic view illustrating the laser beam generation unit 10 of FIG. 1, according to an embodiment of the inventive concepts. FIG. 9 is a schematic view illustrating a laser beam generation unit 30 according to another embodiment of the inventive concepts. The laser beam generation unit 30 can equally apply to FIG. 1.

As illustrated in FIGS. 1 and 8, the laser beam generation unit 10 outputs a carbon dioxide laser beam LB. The laser beam LB can be output at about 30 W or greater.

As illustrated in FIG. 8, the laser beam generation unit 10 may include a first carbon dioxide laser resonator 11. The first carbon dioxide laser resonator 11 may include a sealed type resonance tube 111, a resonance gas 112, total reflector 113, a partial reflector 114, a pair of electrodes 115 and 116, a power unit 117, a wavelength converter 118, an optical fiber 119, and a laser shutter 13. The sealed type resonance tube 111 can comprise an accommodation space therein. The resonance gas 112 is injected into the resonance tube 111 and contains at least a carbon dioxide component. The total reflector 113 is installed at a first side in the resonance tube 111. The partial reflector 114 is installed at a second side in the resonance tube 111. The pair of electrodes 115 and 116 applies flash light energy into the resonance tube 111. The power unit 117 supplies power to the pair of electrodes 115 and 116. The wavelength converter 118 converts or otherwise modifies a wavelength of a carbon dioxide laser beam LB1 generated in the resonance tube 111. The optical fiber 119 guides the carbon dioxide laser beam LB1. The laser shutter 13 can selectively block or otherwise control the output of the carbon dioxide laser beam LB1.

The size of the ball B formed on the wire W may be determined by adjusting a period of time that the laser shutter 13 is opened. That is, the size of the ball B may be reduced by opening the laser shutter 13 for a short period of time so that the carbon dioxide laser beam LB1 is irradiated on the wire W for a period of time commensurate with the opening of the laser shutter 13. The size of the ball B may alternatively be increased by opening the laser shutter 13 for a long period of time so that the carbon dioxide laser beam LB1 is irradiated on the wire W for a period of time commensurate with the opening of the laser shutter 13.

Although not shown in the drawings, the laser beam generation unit 10 may further include a cooling unit for cooling the heated resonance tube 111.

Accordingly, if direct current power is applied to the pair of electrodes 115 and 116, an arc discharge is generated between the pair of electrodes 115 and 116. In response to the arc discharge, the resonance gas 112, for example, a mixed gas in which carbon dioxide, helium, nitrogen, etc. are mixed at predetermined ratios, inside the resonance tube 111 may generate light having a wavelength of, for example, 10.6 micro-wavelength, according to transfer, excitation, and/or transition of energy. Accordingly, when more light is generated inside the resonance tube 111 due to collision of electrons, the light is repeatedly reflected between the total reflector 113 and the partial reflector 114, and some electronic waves are emitted due to resonance. As this sequence is repeated, a laser beam may be output. Here, in order to increase the laser beam output to about 30 W or greater, an output of the power device 117 for supplying power to the pair of electrodes 115 and 116 may be increased. Alternatively, a size of the resonance tube 11 may be increased. Alternatively, a size, performance, and/or positions of the pair of electrodes 115 and 116, the total reflector 113, and the partial reflector 114 may be optimized.

As illustrated in FIG. 9, the laser beam generation unit 30 may include a first carbon dioxide laser resonator 11, a second carbon dioxide laser resonator 12, and a high power output unit 40 in order to obtain a high power laser beam generation unit.

As described above with reference to FIG. 9, the first carbon dioxide laser resonator 11 may include a sealed type resonance tube 111, a resonance gas 112, total reflector 113, a partial reflector 114, a pair of electrodes 115 and 116, a power unit 117, a wavelength converter 118, and an optical fiber 119. The sealed type resonance tube 111 comprises an accommodation space therein. The resonance gas 112 can be injected into the resonance tube 111 and contain at least a carbon dioxide component. The total reflector 113 is installed at a first side in the resonance tube 111. The partial reflector 114 is installed at a second side in the resonance tube 111. The pair of electrodes 115 and 116 applies flash light energy into the resonance tube 111. The power unit 117 supplies power to the pair of electrodes 115 and 116. The wavelength converter 118 converts or otherwise modifies a wavelength of a carbon dioxide laser beam LB1 generated in the resonance tube 111. The optical fiber 119 guides the carbon dioxide laser beam LB1.

The second carbon dioxide laser resonator 12 may include a sealed type resonance tube 121, a resonance gas 122, a total reflector 123, a partial reflector 124, a pair of electrodes 125 and 126, a power unit 127, wavelength converter 128, and an optical fiber 129. The sealed type resonance tube 121 comprises an accommodation space therein. The resonance gas 122 is injected into the resonance tube 121 and contains at least a carbon dioxide component. The total reflector 123 is installed at a first side in the resonance tube 121. The partial reflector 124 is installed at a second side in the resonance tube 121. The pair of electrodes 125 and 126 applies flash light energy into the resonance tube 121. The power unit 127 supplies power to the pair of electrodes 125 and 126. The wavelength converter 128 converts a wavelength of a carbon dioxide laser beam LB2 generated in the resonance tube 121. The optical fiber 129 guides the carbon dioxide laser beam LB2.

The high output unit 40 is a device that combines the first carbon dioxide laser beam LB1 emitted from the first carbon dioxide laser resonator 11 and the second carbon dioxide laser beam LB1 emitted from the second carbon dioxide laser resonator 12. The high output unit 40 may include an inclined total reflector 41 for reflecting the first laser beam LB1 to a path to the shutter 13 and an inclined partial reflector 42 that is installed on the path and passes the first laser beam LB1 through to the path to the shutter 13 and reflects the second laser beam LB2 to the path to the shutter 13. A combination of the first laser beam LB1 and the second laser beam LB2 can be transmitted along some or all of the path to the shutter 13.

Accordingly, the first laser beam LB1 emitted from the first carbon dioxide laser resonator 11 is reflected to the path by the inclined total reflector 41, and the second laser beam LB2 emitted from the second carbon dioxide laser resonator 12 is reflected to the path by the inclined partial reflector 42 so that the first laser beam BL1 and the second laser beam LB2 are consequently combined on the path to output a high output laser beam LB.

Meanwhile, the laser shutter 13 of the laser beam generation unit 30 may selectively block the laser beams LB1 and/or LB2 or otherwise control the output of a laser beam formed from a combination of the laser beams LB1, LB2. Here, the size of the ball B formed on the wire W may be determined by adjusting the period of time that the laser shutter 13 is opened. That is, the size of the ball B may be reduced by opening the laser shutter 13 for a relatively short period of time so that the laser beam LB is irradiated on the wire W for a relatively short period of time. Alternatively, the size of the ball B may be increased by opening the laser shutter 13 for a relatively long period of time so that the laser beam LB is irradiated on the wire W for a relatively long period of time.

FIG. 7 is an expanded view of the laser beam guiding unit 20 illustrated in FIG. 1, according to an embodiment of the inventive concepts.

As illustrated in FIGS. 1 and 7, the laser beam guiding unit 20 guides the laser beam LB emitted from the laser beam generation unit 10 to the ball formation position BP; the laser beam guiding unit 20 may include an optical fiber line 21, a laser beam emitting unit 22, a vertical position adjusting unit 23, a horizontal position adjusting unit 24, and an angle adjusting unit 25.

The optical fiber line 21 is extended from the laser beam generation unit 10 to the laser beam emitting unit 22, thereby forming a path of the laser beam LB.

The laser beam emitting unit 22 may be installed at a tip of the optical fiber line 21 and include an optical fiber, a lens, or a combination thereof. The laser beam emitting unit 22 may function as a type of optical nozzle that determines an irradiation direction of the laser beam LB.

The vertical position adjusting unit 23 is installed on the optical fiber line 21 and adjusts a vertical position of the laser beam emitting unit 22. The vertical position adjusting unit 23 may include a manual adjustment structure for adjusting a position or length of an assembly of the laser beam emitting unit 22 by using various adjustment screws or bolts. Alternatively, an automatic adjustment actuator may be used for adjusting a vertical position of the laser beam emitting unit 22 automatically by using, for example, a motor or a pneumatic/hydraulic cylinder.

The horizontal position adjusting unit 24 is installed at the optical fiber line 21 and adjusts a horizontal position of the laser beam emitting unit 22. The horizontal position adjusting unit 24 may include a manual adjustment structure for adjusting a position or length of assembly of the laser beam emitting unit 22 by using various adjustment screws or bolt. Alternatively, the horizontal position adjusting unit 24 may include an automatic adjustment actuator for adjusting a horizontal position of the laser beam emitting unit 22 automatically by using, for example, a motor or a pneumatic/hydraulic cylinder.

Here, the laser beam guiding unit 20 may include a laser beam guide robot that includes an automatic adjustment actuator for both the vertical position adjusting unit 23 and the horizontal position adjusting unit 24.

The angle adjusting unit 25 is installed on the laser beam guiding unit 20 to adjust an irradiation angle K1 (FIG. 2) of the laser beam LB emitted from the laser beam guiding unit 20 to the ball formation position BP. As illustrated in FIGS. 1 and 7, the angle adjusting unit 25 may include a joint portion 252 having a hinge axis 251 for adjusting the irradiation angle K1 of the laser beam emitting unit 22 illustrated in FIG. 2. The irradiation angle K1 may be about 40 to 50 degrees with respect to an axis direction of the wire W. That is, the laser beam emitting unit 22 may include a first laser beam emitting unit 221 disposed such that the irradiation angle K1 thereof may be about 40 to 50 degrees with respect to the axis direction of the wire W.

Accordingly, the laser beam LB emitted from the first laser beam emitting unit 221 is irradiated to the wire W at an angle so as to be uniformly irradiated to a lateral surface and a bottom surface of the wire W. Accordingly, the lateral surface and the bottom surface of the wire W are uniformly heated to facilitate speed of formation of the ball B. The ball B is not biased but is formed in a more perfect spherical shape.

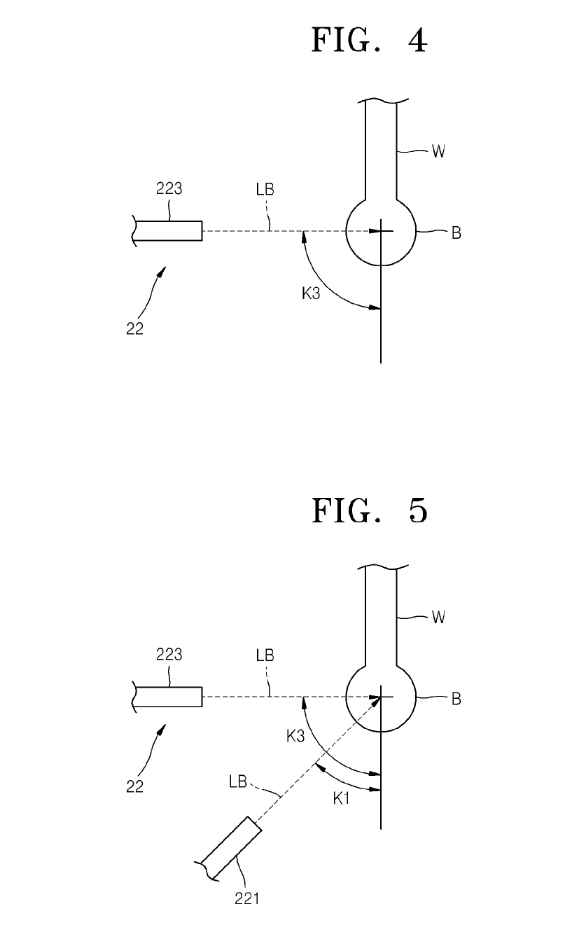

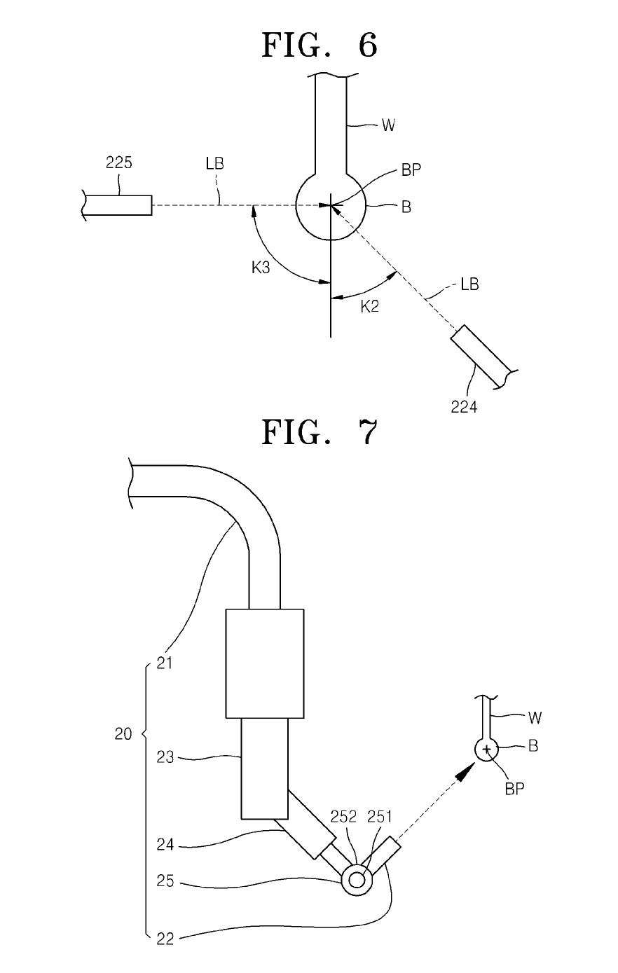

FIG. 3 is an expanded view of the laser beam emitting unit 22 illustrated in FIG. 1, according to another embodiment of the inventive concepts. FIG. 4 is an expanded view of the laser beam emitting unit 22 illustrated in FIG. 1, according to another embodiment of the inventive concepts. FIG. 5 is an expanded view of the laser beam emitting unit 22 illustrated in FIG. 1, according to another embodiment of the inventive concepts. FIG. 6 is an expanded view of the laser beam emitting unit 22 illustrated in FIG. 1, according to another embodiment of the inventive concepts.

As illustrated in FIG. 3, the laser beam emitting unit 22 may include a first laser beam emitting unit 221 disposed such that an irradiation angle K1 thereof may be about 40 to 50 degrees with respect to an axis direction of a wire W and a second laser beam emitting unit 222 disposed such that an irradiation angle K2 thereof may be about 40 to 50 degrees with respect to the axis direction of the wire W.

Accordingly, laser beams LB emitted from the first laser beam emitting unit 221 and the second laser beam emitting unit 222, respectively, may be irradiated on the wire W so as to be irradiated on two lateral surfaces and a lower surface of the wire W at the same time. Accordingly, the two lateral surfaces and the bottom surface of the wire W are uniformly heated to facilitate formation speed of a ball B. The ball B is not biased but is formed in a more perfect spherical shape. In addition, due to the application of the two laser beams LB, the ball B may be formed more quickly.

As illustrated in FIG. 4. the laser beam emitting unit 22 may include a third laser beam emitting unit 223 disposed such that an irradiation angle K3 thereof may be about 85 to 95 degrees with respect to an axis direction of a wire W.

Accordingly, a laser beam LB emitted from the third laser beam emitting unit 223 may be irradiated on a lateral surface of the wire. Accordingly, the lateral surface of the wire W is heated so as to facilitate a speed of formation of a ball B.

As illustrated in FIG. 5, the laser beam emitting unit 22 may include a first laser beam emitting unit 221 disposed such that an irradiation angle K1 thereof may be about 40 to 50 degrees with respect to an axis direction of a wire W and a third laser beam emitting unit 223 disposed such that an irradiation angle K3 thereof may be about 85 to 95 degrees with respect to the axis direction of the wire W.

Accordingly, laser beams LB emitted from the first laser beam emitting unit 221 and the third laser beam emitting unit 223, respectively, may be irradiated on a lateral surface and a lower surface of the wire W at the same time, and accordingly, the lateral surface and the bottom surface of the wire W are uniformly heated to facilitate speed of formation of a ball B, and the ball B is not biased but is formed in a more perfect spherical shape.

As illustrated in FIG. 6, the laser beam emitting unit 22 may include a second laser beam emitting unit 222 disposed such that an irradiation angle K2 thereof may be about 40 to 50 degrees with respect to an axis direction of a wire W and a third laser beam emitting unit 223 disposed such that an irradiation angle K3 thereof may be about 85 to 95 degrees with respect to the axis direction of the wire W.

Accordingly, laser beams LB respectively emitted from the second laser beam emitting unit 222 and the third laser beam emitting unit 223 may be irradiated on the wire W so as to be irradiated on two lateral surfaces and a lower surface of the wire W at the same time. Accordingly, the two lateral surfaces and the bottom surface of the wire W are uniformly heated to facilitate speed of formation of a ball B. The ball B is not biased but is formed in a more perfect spherical shape.

The number and positions of the laser beam emitting units 22, for example, the first laser beam emitting unit 221, the second laser beam emitting unit 222, and the third laser beam emitting unit 223, alone or in combination, may be optimized in consideration of costs, moldability of a ball B, and space restrictions, and are not limited to as illustrated in the drawings.

Thus, according to the wire bonding system for a semiconductor package according to the embodiments of the inventive concepts, at least one high output carbon dioxide laser beam can be disposed such that an irradiation angle thereof may be about 45 degrees and can have an output of about 30 W or greater. The laser beam may be emitted to a front end of a wire, for example, to a lateral surface and a bottom surface of a wire W, so as to quickly form a spherical ball B having a small size and a precise and uniform shape, thereby significantly improving moldability of the ball B. Accordingly, productivity may be increased by reducing time for forming the ball B. Also, the ball B can be formed having a more uniformly formed spherical shape. A size of the ball B may be precisely adjusted by adjusting the opening time of the laser shutter 13. In the wire bonding system for a semiconductor package according to the embodiments of the inventive concepts, the opening time of the laser shutter 13 may be adjusted to be 100 ms or shorter by using a carbon dioxide laser beam having a high output of 30 W or higher. Here, the opening time of the laser shutter 13 is reduced as the output is increased, thereby further improving productivity.

In addition, several malfunctions such as formation of balls having a defective shape or failure to generate a spark due to soot generated by an electric spark or due to adsorption of foreign materials at a torch tip according to the conventional art may be prevented. In addition, inconvenience of exchanging a torch tip due to use for a long period of time may be prevented, thereby reducing costs and time for exchanging several consumed components. That is, as the laser beam emitting unit 22 emits a laser beam, soot, discoloring, and abrasions are not formed. Thus, the laser beam emitting unit 22 may be used permanently or semi-permanently. Consequently, time and costs for unnecessary exchange of components may be prevented or reduced.

Although a section in which an electrical property is modified, for example, a section of about 250 to 350 micrometers, is generated in a wire W due to an electrical spark impact of a torch tip according to the conventional art to harden the wire W, this hardened wire portion corresponds to a minimum loop height of the wire W. However, according to the wire bonding system for a semiconductor package of the inventive concepts, the above-described section in which an electrical property is modified is not generated or is only a minimum section, for example, a section of about 250 micrometers or shorter, and ductility of the wire W in remaining sections is maintained, thereby minimizing the loop height LH of the wire W, for example, shown in FIG. 1.

In addition, since an electrical spark is generated at a torch tip more easily as the torch tip gets nearer to the wire W according to the conventional art, there is no distance between the torch tip and the wire W. Accordingly, the torch tip and the wire W are likely to collide with each other, thereby frequently causing an over-discharge or failure to generate a discharge. However, according to the embodiments of the inventive concepts, it is not necessary that a distance between the laser beam emitting unit 22 and the ball B be small, and thus a sufficient distance, for example, about 100 to 150 micrometers or greater, may be maintained therebetween.

While the inventive concepts has been particularly shown and described with reference to exemplary embodiments thereof, it will be understood that various changes in form and details may be made therein without departing from the spirit and scope of the following claims.

What is claimed is:

1. A wire bonding system for a semiconductor package, comprising:
a wire feeding device for positioning a wire at a ball formation position;
a laser beam generation unit for generating at least one laser beam; and
a laser beam guiding unit for directing the at least one laser beam at the ball formation position to form a ball at the wire.

2. The wire bonding system of claim 1, wherein the laser beam generation unit includes a high power laser beam output unit.

3. The wire bonding system of claim 1, wherein the laser beam generation unit comprises a first carbon dioxide laser resonator, the first carbon dioxide laser resonator comprising:
a sealed resonance tube;
a resonance gas that is injected into the sealed resonance tube, the resonance gas including at least a carbon dioxide component;
a total reflector constructed and arranged at a first side in the sealed resonance tube;
a partial reflector constructed and arranged at a second side in the sealed resonance tube;
a pair of electrodes for applying flash light energy into the sealed resonance tube; and
a power unit for supplying power to the pair of electrodes.

4. The wire bonding system of claim 3, wherein the laser beam generation unit comprises a second carbon dioxide laser resonator, the second carbon dioxide laser resonator comprising:
a sealed resonance tube;
a resonance gas that is injected into the sealed resonance tube, the resonance gas including at least a carbon dioxide component;
a total reflector mirror constructed and arranged at a first side in the sealed resonance tube;
a partial reflector mirror constructed and arranged at a second side in the sealed resonance tube;
a pair of electrodes for applying flash light energy into the sealed resonance tube; and
a power unit for supplying power to the pairs of electrodes.

5. The wire bonding system of claim 4, further comprising at least one high output unit that combines a first laser beam emitted from the first carbon dioxide laser resonator and a second laser beam emitted from the second carbon dioxide laser resonator.

6. The wire bonding system of claim 5, wherein the high output unit comprises an inclined total reflector and an inclined partial reflector.

7. The wire bonding system of claim 1, further comprising an angle adjusting unit that is installed on the laser beam guiding unit and adjusts an irradiation angle of a laser beam emitted from the laser beam guiding unit to the ball formation position.

8. The wire bonding system of claim 7, wherein the angle adjusting unit comprises a joint unit having a hinge axis.

9. The wire bonding system of claim 7, wherein the irradiation angle is about 40 to 50 degrees with respect to an axis direction of a wire.

10. The wire bonding system of claim 1, wherein the laser beam guiding unit comprises:
an optical fiber line that is extended from the laser beam generation unit;
a laser beam emitting unit that is installed at a tip of the optical fiber line and comprises an optical fiber, a lens, or a combination thereof;
a vertical position adjusting unit that is installed on the optical fiber line and adjusts a vertical position of the laser beam emitting unit; and
a horizontal position adjusting unit that is installed on the optical fiber line and adjusts a horizontal position of the laser beam emitting unit.

11. The wire bonding system of claim 10, wherein the laser beam emitting unit comprises a first laser beam emitting unit disposed at an irradiation angle of about 40 to 50 degrees with respect to an axis direction of the wire.

12. The wire bonding system of claim 11, wherein the laser beam emitting unit comprises a second laser beam emitting unit disposed at an irradiation angle of about 40 to 50 degrees with respect to an axis direction of the wire on a side opposite the first laser beam emitting unit.

13. The wire bonding system of claim 10, wherein the laser beam emitting unit comprises a third laser beam emitting unit disposed at an irradiation angle of about 85 to 95 degrees with respect to the axis direction of the wire.

14. The wire bonding system of claim 1, wherein the wire feeding device comprises:
a spool on which the wire is wound;
a wire tensioning device for maintaining the wire unwound from the spool, in a vertical state;
a wire clamp for selectively clamping the wire in the vertical state;
a transducer for applying a minute vibration to the wire; and
a capillary for fixing a front end position of the wire to perform wire bonding.

15. The wire bonding system of claim 1, wherein the laser beam output unit outputs at least one carbon dioxide laser beam.

16. A wire bonding system for a semiconductor package, comprising:
a wire feeding device for positioning a wire at a ball formation position;
a laser beam generation unit for generating at least one laser beam; and
a laser beam guiding unit for directing the at least one laser beam generated from the laser beam generation unit at the ball formation position at an angle of about 40 to 50 degrees with respect to a direction of extension of the wire.

17. A system for forming a ball on a wire at a semiconductor package, comprising:
a laser beam generation unit for generating at least one carbon dioxide laser beam; and
a laser beam guiding unit for directing the at least one carbon dioxide laser beam at a region of the wire.

18. The system of claim 17, further comprising a wire feeding device for positioning the wire at a direction of extension, a region of the wire including a ball formation position, the laser beam guiding unit directing the at least one carbon dioxide laser beam at the ball formation position to form the ball.

19. The system of claim 17, wherein the laser beam generation unit comprises a laser shutter for determining a size of the ball formed on the wire.

20. The system of claim 17, wherein the laser beam guiding unit includes a laser beam emitting unit that directs the at least one carbon dioxide laser beam at the region of the wire at an irradiation angle with respect to the direction of extension of the wire.
